(19) United States
(12) Patent Application Publication
(10) Pub. No.: US 2004/0230550 A1
(43) Pub. Date: Nov. 18, 2004

(54) METHOD AND APPARATUS FOR ELECTRONIC FILING OF PATENT AND TRADEMARK APPLICATIONS AND RELATED CORRESPONDENCE

(76) Inventors: Michael J. Simpson, Youngstown, NY (US); Robert P. Simpson, Williamsville, NY (US); Neil Hauser, Rochester, NY (US); Brendan J. Shaw, Williamsville, NY (US); Kevin D. Koch, Rochester, NY (US); Chris Barbara, Staten Island, NY (US); Jason Lee, Plano, TX (US)

Correspondence Address: SIMPSON & SIMPSON, PLLC, 5555 MAIN STREET, WILLIAMSVILLE, NY, 14221-5406, US

(21) Appl. No.: 10/249,377

(22) Filed: Apr. 3, 2003

(51) Int. Cl. G06F 7/00

(52) U.S. Cl. 707/1

(57) ABSTRACT

A computer-based method and apparatus for electronically preparing extensible markup language (XML) files includes means for preparing extensible markup language files (XML) from native word processing source files, such as MICROSOFT® Word (.doc) or COREL® WORDPERFECT® (.wpd), electronically transmitting the extensible markup language (XML) files to an intended recipient via a global information network and means for accounting for fees related to the electronic submission of the files to the intended recipient. In a preferred embodiment the computer based means and methods may be utilized to electronically prepare and file intellectual property related correspondence with the United States Patent and Trademark Office or other intellectual property offices.

### REFERENCE TO A COMPUTER PROGRAM

This patent incorporates herein by reference the computer program contained in the attached text file, named legp101us5341-uscomp.txt. 4.94 MB. This software code listing is intended to enable one having ordinary skill in the art to be able to make the present invention.

### FIELD OF THE INVENTION

The present invention relates generally to a method and apparatus for creating an extensible markup language (XML) file from a native word processing file and, optionally, transmitting the extensible markup language file to an intended recipient via a global information network. More particularly, the present invention relates to a computer-based method and apparatus for electronically preparing and processing word-processing files, such as patent and trademark applications and/or related correspondence using commercially available word processing software, identifying critical attributes within the word processing files and then electronically transmitting the files to an intended recipient such as the United States Patent and Trademark Office, or other national patent or trademark office. The present invention also provides a method and apparatus for accounting for fees related to electronic filing of intellectual property related correspondence.

### BACKGROUND OF THE INVENTION

Each year, hundreds of thousands of patent and trademark applications and millions of pieces of related correspondence are filed with patent and trademark offices around the world. Despite advances in technology and the widespread availability of global information networks for transmitting correspondence and information and data, a surprisingly high percentage of patent and trademark applications and related correspondence continue to be filed on paper and delivered by regular mail or courier services. For example, in 2002 alone, approximately 353,394 utility, design, plant and reissue applications for patent and 258,873 applications for the registration of trademarks were filed with the United States Patent and Trademark Office (USPTO). More than 2,000,000 ancillary paper documents were filed by practitioners related to the above-mentioned applications, and more than 500,000 assignment documents were filed as well. These numbers are expected to double by 2006. Despite these staggering figures and projections, and the availability of USPTO electronic filing software (TEAS and EFS), the USPTO has reported that only about 30% of all trademark applications and 2% of all patent applications are presently filed electronically. It is clear that the USPTO is under siege by a labor-intensive paper patent and trademark system.

In an attempt to alleviate the paper problem and improve efficiencies, and as mandated by the Paperwork Reduction Act of 1995, Public Law 104-13, the USPTO submitted an aggressive 21st Century Strategic Plan to Congress on Jun. 3, 2002 (the Plan was then updated and revised on Feb. 3, 2003). While the Strategic Plan addresses a wide scope of Patent and Trademark Office activities and operation, it specifically targets implementation of automation for patent and trademark applications with a goal to, “Deliver an operational system to process patent applications electronically by Oct. 1, 2004, including electronic image capture of all incoming and outgoing paper documents.” (21st Century Strategic Plan, United States Patent and Trademark Office, Jun. 3, 2002, page 6). This commitment is highlighted in the introductory message of Under Secretary of Commerce for Intellectual Property and Director of the U.S. Patent and Trademark Office, James E. Rogan, in the Annual Report of the USPTO for 2002, where he states, “We established patent electronic filing partnerships to assist us in moving toward a full paperless patent process by the end of 2004, and continued to expand the number of trademark applications and documents that can be filed electronically to permit nearly all trademark communications to be conducted in this medium.” (United States Patent and Trademark Office, Annual Report 2002, Dec. 30, 2002, page 2).

To meet the goal of a full paperless patent process by the end of 2004, the USPTO awarded five electronic filing contracts to private companies on Jun. 18, 2002. The assignee of this patent was awarded one of these contracts. (USPTO Annual Report, supra, pages 2, 12-13).

In analyzing the problem to be solved, it is clear that there are a number of reasons why most practitioners do not presently file patent and trademark applications electronically. First, existing software for electronically filing patent and trademark applications is not very user friendly. Second, practitioners have concerns about security in transmitting confidential information electronically, and are concerned about the dependability and availability of servers, modems and the Internet for transmitting patent and trademark applications and related correspondence close to due dates, or even worse, statutory bar dates. Third, existing systems require practitioners to learn new ways of practicing law and or preparing their documents, which requires the expense of training attorneys, agents, paralegals and secretaries. The existing paper-based system has been in place, in one form or another, with and without computer assistance, for more than 200 years. For the most part, the existing system works—from the perspective of practitioners. That is, the paper is manageable and even somewhat efficient for the practicing bar, even while its sheer volume inundates and slows down the Patent Office. Like a snowball rolling down a mountain, the paper patent system has gained considerable momentum and inertia in all those years. It will take a great deal of effort, and affordable, user-friendly software, to send that avalanche-causing snowball down a more efficient slope on the mountain. Fourth, it has long been the duty of intellectual property law firms to keep their clients informed of progress in the matters entrusted to them, and this duty has traditionally been met in part by sending copies of paper filed documents to the clients. Fifth, many practitioners take pride, not only in the technical and legal aspects of their writings, but also in the aesthetic appearance of their writings; such aesthetic appearance is often lacking when existing electronic software solutions are used. Sixth, it is a concern that the costs of private vendor electronic filing software and/or subscription based licenses for electronic filing software might be cost prohibitive.

Developing electronic filing software that will be embraced by more than 26,000 practicing patent attorneys and agents, and their respective paralegal and clerical staffs, capable of processing hundreds of thousands of complex patent applications, many of which include formulae, mathematical equations, software code listings, DNA sequence listings, tables, and drawing figures, is no small task. It is compounded by the fact that practitioners use different native software applications to prepare patent applications and related correspondence. Some practitioners use MICROSOFT® Word software to prepare patent-related documents, while others use COREL® WORDPERFECT® software, or other software. Some patent drawings are hand-drawn using India ink on Bristol board, others are drawn using computer aided drawing (CAD) software. How does one enable practitioners to use the same word processing software they have always used, and yet convert the native documents into a standard XML file that the PTO can accept and use? How does one provide a software solution that facilitates both hand-drawn and computer drawn patent drawings? It is expected that some electronic filing partners will offer solutions tied to a specific word processing application (e.g., MICROSOFT® Word), while others may develop solutions that are independent of commercial word processing software, i.e., an independent “stand-alone” application. Some may require CAD generated drawings, and not accommodate hand-drawn patent drawings.

In an effort to stimulate the electronic filing of trademark applications and related correspondence, the United States Patent and Trademark Office has proposed fee incentives for those whom electronically file trademark applications and related correspondence. Once the financial incentive rules become final, trademark practitioners are expected to save fees for trademark applications filed electronically, in addition to postage expense. Those who continue to file applications on paper will be assessed a filing fee differential. It is expected that similar differentials will be implemented for the filing of patent applications and related correspondence, i.e., practitioners will have to pay a higher filing fee if they file on paper as opposed to filing electronically.

In addition to the electronic filing issues described above, practitioners in intellectual property law firms have long faced accounting problems with respect to patent and trademark applications and related correspondence filed on paper. Postage is not an insignificant expense for most intellectual property law firms and intellectual property departments in corporations. While most patent and trademark correspondence is sent via first class mail, a large percentage of patent and trademark applications and other correspondence is filed by Express Mail, pursuant to 37 C.F.R. §1.10, at significantly higher postal rates. While some law firms do not pass these expenses onto their clients, many do. Law firms passing their mailing expenses onto their clients must account for these expenses. While the weighing and posting of mail has been largely automated, including the use of digital postal scales, preprogrammed with postal rates, and the ability to buy postage on-line or by telephone for postal meters, it is somewhat surprising that affordable software to link those postal machines to time and billing software used by law firms simply does not exist. As a result, most law firms that track postage expense and pass that expense to their clients, track the postage expense manually. Many firms keep paper postage expense logs (i.e., a note book) proximate a postal meter, and manually record each postal expense for each piece of correspondence mailed. This logged information is subsequently manually entered into time and billing software, so that each respective client can be billed for its individual postal disbursements. Clients typically require law firm bills to reflect postage as an itemized expense, and some clients even require a breakdown of this expense by each matter and/or file.

Finally, it goes without saying that physically taking mail to the Post Office to obtain a date stamp on an Express Mail mailing label is not the most efficient use of anyone's time. Yet this is precisely what thousands of patent attorneys, agents, paralegals, secretaries and legal staff members do on a daily basis. The local post office has become a veritable meeting place for patent attorneys rushing to meet their clients' deadlines and protect their clients' valuable intellectual property rights.

What is needed, then, is user-friendly, efficient, and affordable software for electronic filing of patent and trademark applications and related correspondence, which software integrates with existing commercially available word processing software, and solves the existing manual postal bookkeeping problems by charging practitioners predetermined fixed fees for electronic filing, which fees are automatically accounted for, and stored in a database for easy export to popular time and billing software packages.

### SUMMARY OF THE INVENTION

The present invention broadly comprises a computer-based method and apparatus for electronically preparing extensible markup language (XML) files from native word processing source files such as MICROSOFT® Word (“.doc”) or COREL® WORDPERFECT® (“.wpd”) files. The invention further comprises means and methods for transmitting the extensible markup language (XML) files to an intended recipient via a global information network and also includes means and methods for accounting for fees related to electronically filing patent and trademark related correspondence. The invention also comprises means and methods for converting forms based files to extensible markup language (XML) files and drawing files to Tag Image Format Files (TIFF) for transmission to an intended recipient via a global information network. Finally, the invention also comprises means and methods for purchasing electronic postage (ePostage) via a global information network, which electronic postage is used as payment for software license fees for electronic submission of correspondence.

The apparatus of the present invention generally comprises a computer-implemented software application for implementing the methods of the present invention. The method of the present invention broadly includes the steps of preparing an electronic word processing file, such as a MICROSOFT® Word or COREL® WORDPERFECT® file, creating a text format (ASCII) file from the word processing source file, creating a rich text format (rtf) file from the word processing source file, filtering the text format (ASCII) and rich text format (rtf) files to create a raw field-based data file, creating an extensible markup language (XML) file from the raw field based data file and, optionally, communicating the extensible markup language (XML) file to an intended recipient via a global information network.

Thus, a primary object of the present invention is to provide a computer-based method and apparatus for creating an extensible markup language (XML) file from a native word processing source file such as that produced by MICROSOFT® Word, COREL® WORDPERFECT®, or other word processing software applications.

Another object of the present invention is to provide a method and apparatus for creating an extensible markup language file (XML) file from a form based file, and creating a TIFF file from a drawing file.

Yet another object of the present invention is to provide a method and apparatus for electronically transmitting an extensible markup language (XML) file, text based file and/or Tag Image Format File (TIFF) to an intended recipient.

A further object of the present invention is to provide a method and apparatus for automatically accounting for fees related to electronically filed patent and trademark applications and related correspondence.

These and other objects, features and advantages of the invention will become apparent upon reading the following detailed description and the appended drawings and claims.

### BRIEF DESCRIPTION OF THE DRAWINGS

The nature and mode of operation of the present invention will now be more fully described in the following detailed description of the invention read together with the accompanying drawing figures, in which:

FIG. 1 is a flow chart of the software application of the present invention, which broadly illustrates the primary modules for electronically preparing and filing patent and trademark applications and related correspondence via a global information network;

FIG. 2 is a flow chart which illustrates the method implemented by the forms module of the present invention;

FIG. 3 is a flow chart which illustrates the method implemented by the documents module of the present invention;

FIG. 4 is a flow chart which illustrates the method implemented by the drawings module of the present invention;

FIG. 5 is a flow chart which illustrates the electronic postage module of the present invention;

FIG. 6 is a flow chart which illustrates the electronic filing module of the present invention;

FIG. 7 is a flow chart which illustrates the word processing parsing module of the present invention;

FIG. 8 is a flow chart which illustrates the XML rendering module of the present invention;

FIG. 9 is a screen capture of the main screen of the present invention;

FIG. 10 is a screen capture of the “Prepare Forms” screen of the present invention;

FIG. 11 is a screen capture of a form that has been selected for preparation;

FIG. 12 is a screen capture of the “Create Documents” screen of the present invention;

FIG. 13 is a screen print of a Document that has been selected for preparation and/or editing;

FIG. 14 is a screen capture of an image file that has been selected for importation;

FIG. 15 is a screen capture of the color-coded “ePostage” meter of the present invention;

FIG. 16 is a screen capture of the submission type module of the present invention;

FIG. 17 is a screen capture of the “ePostage” order form of the present invention;

FIGS. 18-20 are screen captures of the user validation module of the present invention; and,

FIG. 21 is a screen capture of the electronic automatic validation and submission module of the present invention.

### DETAILED DESCRIPTION OF A PREFERRED EMBODIMENT

It should be appreciated at the outset that, in the detailed description that follows, like reference numbers on different drawing views are intended to identify identical structural elements of the invention in the respective views. It should also be appreciated that, for purposes of the present invention and claims, the terms “file” and/or “document” are intended to refer to paper documents and/or various forms of electronic documents and files; for example a word processing document or file may comprise a paper document (upon printing) or an electronic document or file that may be viewed by means of a monitor, saved in a memory storage device, electronically transmitted, etc. Additionally, as used herein, the term “native”, as it applies to software applications and/or word processing applications, documents or files, is intended to refer to a primary file type produced by, used by, and/or identified by a manufacturer of a software application. For example, “.doc” is the native file type for MICROSOFT® Word. A native file type does not comprise extensible markup language (XML) authoring tools embedded therein. It should also be appreciated that, while a preferred embodiment of the present invention contemplates and comprises electronic filing via a global information network (e.g., the Internet), the term “electronic filing” is not intended to be so limited. The term is intended to include a wide variety of electronic communication methods, both wired and wireless. For example, filing might be accomplished by modem, cable or DSL (wired techniques), or by any number of wireless techniques (e.g., satellite, cellular or RF communication). Finally, it should be appreciated that while we describe “filing”, “submission” and “correspondence” fees herein, the term “filing” as it relates to fees is intended to refer to official government fees associated with filing correspondence with a government agency. The terms “submission” and “correspondence”, as they relate to fees, are intended to refer to a transaction based license fee incurred by a user in exchange for use of the software of the present invention, such “submission” or “correspondence” fees may be debited from a user's ePostage account as described infra, whereas “filing” fees typically are not.

Our description of a preferred embodiment begins with a brief overview of the software application of the present invention, known commercially as IP IntelliFile™, developed by LegalStar, Inc. of Williamsville, N.Y., assignee of this patent. It should be appreciated by those having ordinary skill in the art, however, that while the preferred embodiment disclosed herein is specifically configured to comprise a method and apparatus for electronically preparing and filing patent and trademark related correspondence with the United States Patent and Trademark Office and/or other foreign intellectual property offices, the present invention may be configured for electronically preparing and transmitting virtually any type of document or file to any intended recipient.

The present invention broadly comprises a computerized method and apparatus for electronically preparing an extensible markup language (XML) file from a native word processing source file, such as a MICROSOFT® Word file having a “.doc” file extension or a COREL® WORDPERFECT® file having a “.wpd” file extension, and, optionally, electronically transmitting the extensible markup language (XML) files to an intended recipient via a global information network, e.g., the Internet. It should be appreciated that while word processing applications comprising embedded extensible markup language (XML) authoring tools are known, it is believed that no one heretofore has developed a software application for creating an extensible markup language (XML) file from a pure, native word processing file.

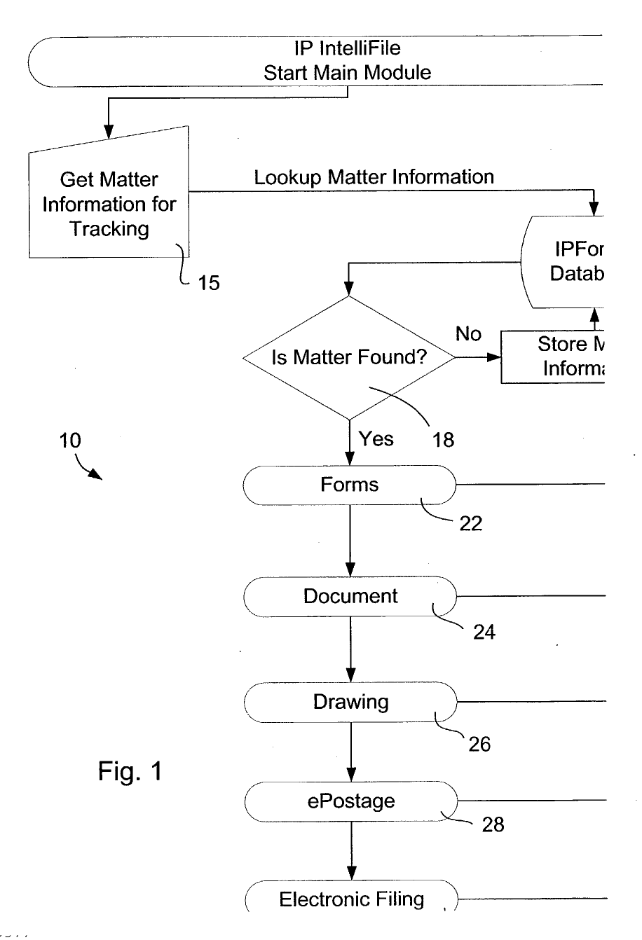

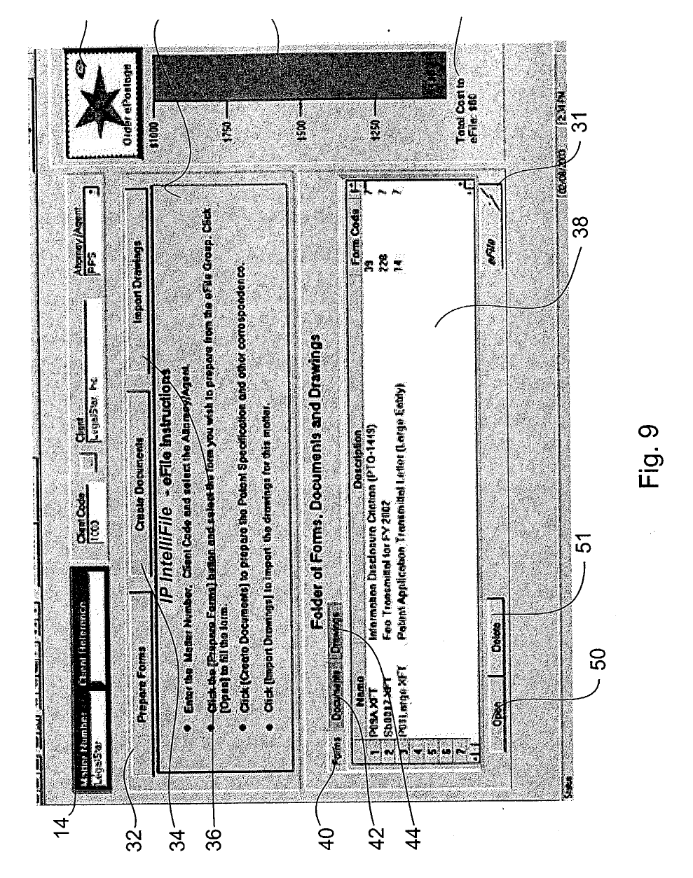

Adverting now to the Figures, the software application of the present invention is broadly illustrated in FIGS. 1, 9-10 and 12. More specifically, FIG. 1 is a flow chart that illustrates the general method implemented by the present invention and FIGS. 9-10 and 12 illustrate the main screen of the present invention. As is apparent from FIG. 1, the operational modules of software application 10 of the present invention generally comprise tracking module 15, IPForms database 16, matter verification module 18, storage module 20, Forms module 22, Documents module 24, Drawings module 26, ePostage module 28 and electronic filing module (eFile module) 30. Similarly, as is apparent from FIGS. 9-10 and 12, main screen 12 generally comprises “eFile” button 31, “Prepare Forms” button 32, “Create Documents” button 34, “Import Drawings” button 36, “Folder of Forms, Documents and Drawings” frame 38, “Forms” tab 40, “Documents” tab 42, “Drawings” tab 44, “ePostage” frame 45 comprising “ePostage” meter 46 and “ePostage” button 48, “Open” button 50, “Delete” button 51 and instructions frame 53.

The following detailed description explains how a user would use the software of the invention to prepare and file a patent or trademark application, or related correspondence using the present invention. This description is intended to enable one having ordinary skill in the art to be able to use the invention.

Adverting to FIG. 9, upon launch of the software application of the present invention, main screen 12 is opened and the user is prompted to enter an alphanumeric identifier in field 14 corresponding to a particular matter to be worked on. Patent and trademark practitioners would typically refer to this identifier as a matter number or docket number. In a preferred embodiment, this identifier is unique. It should be appreciated that the alphanumeric identifier may comprise a client name, client code, docket number, matter number, etc.; virtually any suitable indicia one may desire to identify a particular matter. Upon entering the alphanumeric identifier, IPForms database 16 (FIG. 1) is queried by query module 15 (FIG. 1) in an effort to determine whether a particular matter is already correlated with the alphanumeric identifier. If data is associated with the matter number, information is displayed in the “Folder of Forms, Documents and Drawings” frame 38 (FIG. 9). As shown in FIG. 1, if no matter exists, the user is prompted to open a new matter and enter all pertinent information regarding the matter; this information is then stored within iPForms database 16 by storage module 20. Adverting again to FIG. 9, once an alphanumeric identifier is created and/or all data related to a matter is displayed in “Folder of Forms, Documents and Drawings” frame 38, the user may then prepare, edit, delete, etc., new or existing forms and documents, and add or import drawings associated with the matter. This is accomplished via “Prepare Forms” button 32, “Create Documents” button 34, and “Import Drawings” button 36, which buttons activate Forms module 22, Documents Module 24 and Drawings Module 26, respectively. In a preferred embodiment, these button are used to complete intellectual property forms, prepare a patent application or related correspondence, or prepare patent drawings for filing, respectively.

It should be appreciated that the user may view existing files associated with a matter by selecting the Forms tab 40, Documents tab 42 or Drawings tab 44, highlighting the desired filename in “Folder of Forms, Documents and Drawings” frame 38 and clicking Open button 50. Similarly, a user may delete a document by highlighting the desired filename in “Folder of Forms, Documents and Drawings” frame 38 and clicking Delete button 51. Upon completing all desired documents, the user may then save the files within the IPForms database and/or electronically submit the documents to an intended recipient, such as the United States Patent and Trademark Office, by clicking eFile button 31, which activates electronic filing module 30 (FIG. 1).

Forms Module

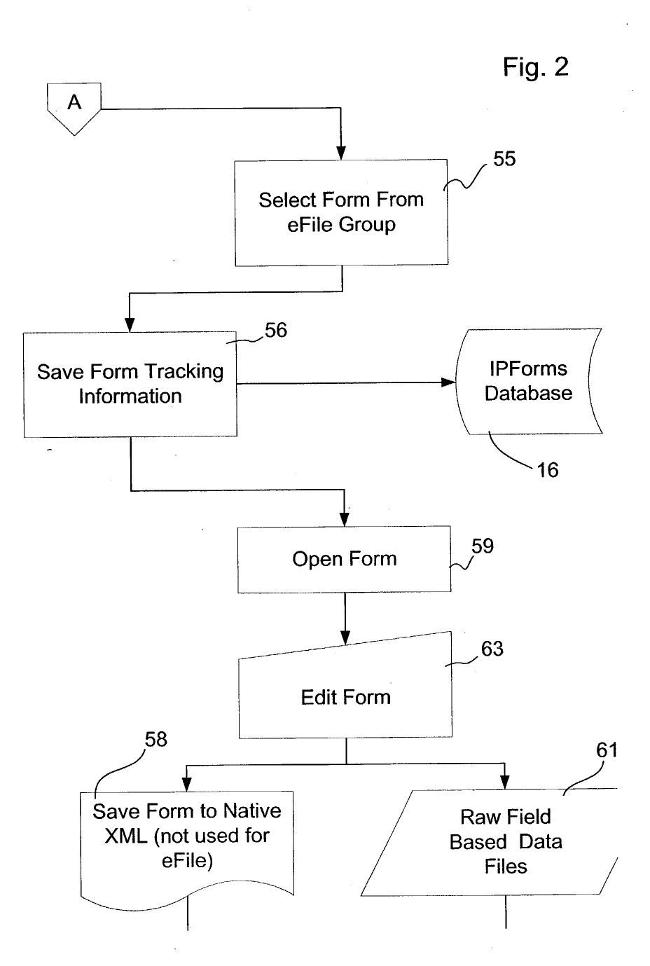

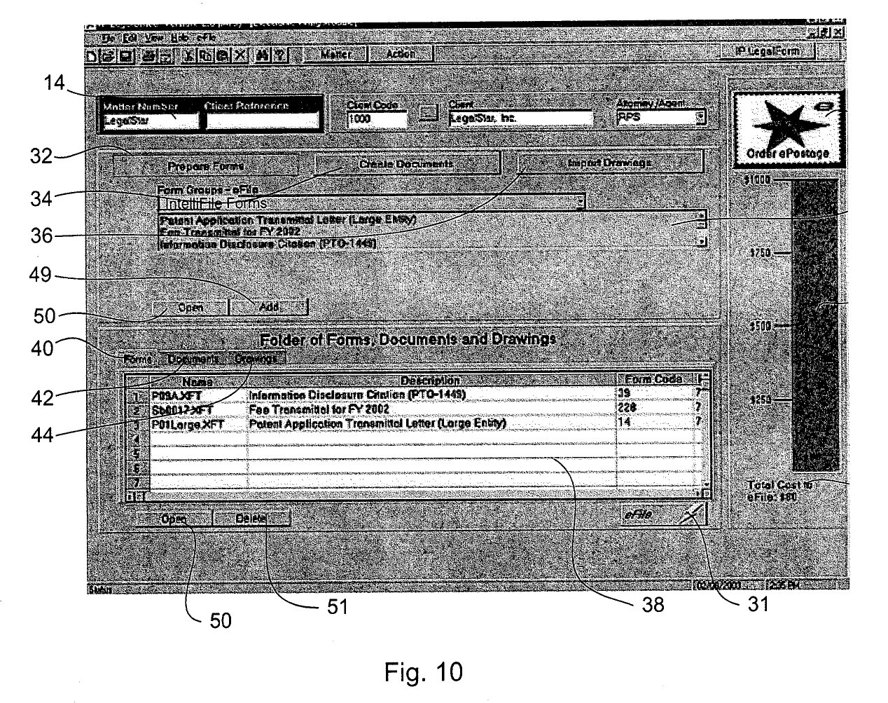

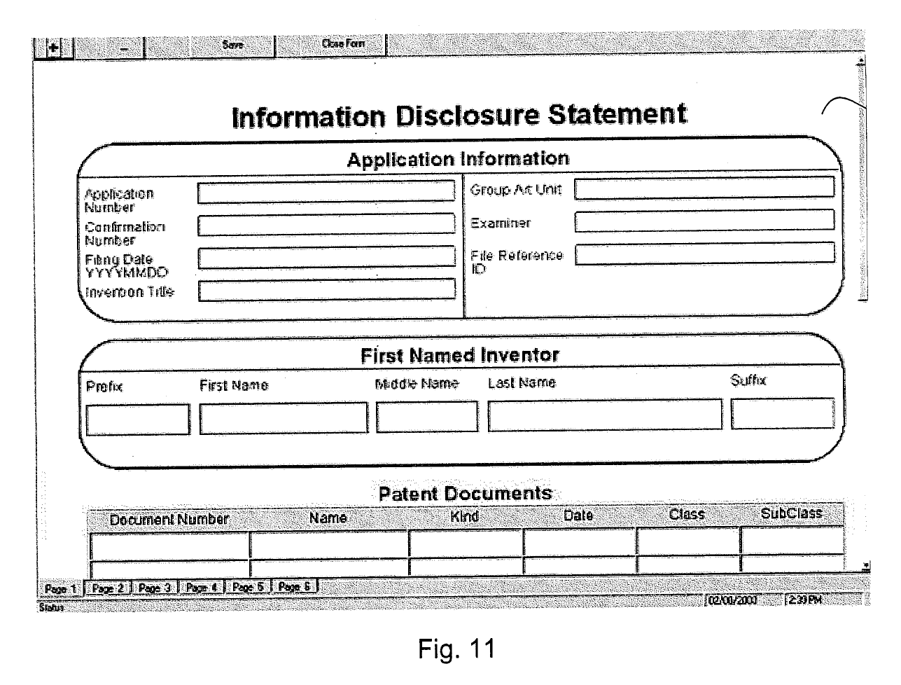

Forms Module 22 (shown in FIG. 1) enables a user to electronically prepare and transmit electronic forms to an intended recipient, such as the United States Patent and Trademark Office, or other intellectual property office. Forms that may be prepared and submitted may include, but are not limited to, Information Disclosure Statements, Fee Transmittal Sheets, Request Forms, and any other form necessary to prosecute a patent application. As shown in FIGS. 2, 10 and 11, if a user desires to select a form for preparation and/or editing (method step 55 in FIG. 2), “Prepare Forms” button 32 may be selected from the main screen (FIG. 9). To prepare a new form a user first selects a form type from forms list 47 (FIG. 10). Upon selecting a form from main screen 12, “Add” button 49 may be selected to launch form 57 (see FIG. 11). FIG. 11, for example, illustrates Information Disclosure Statement form 57 open on the screen and ready for completion. Selecting “Add” button 49 also saves form tracking information (method step 56) in IPForms database 16. Thereafter the desired form is opened (method step 59) and the user is prompted to input/edit the required information in all relevant fields (method step 63). To complete, or fill, the form, a user simply types information in a field, hits the Enter or Tab key, and the cursor tabs from field to field throughout the form. Upon completing form 57, the user may close or save the form, which automatically saves the form as a native extensible markup language (XML) file (method step 58) and as a raw field data file (method step 61). The saved native extensible markup language (XML) file comprises the file that is electronically displayed to the user whereas the raw field data file comprises a precursor data file. Alternatively, if a saved form requires editing, the user may highlight the filename of the saved form in the “Folder of Forms, Documents and Drawings” frame 38, click open button 50 to open the desired file, perform editing as necessary, and close or save the file as described above.

Document Module

The software application of the present invention is uniquely adapted to allow the user to prepare patent and trademark applications and related correspondence as the user has always done in the past, by using word processing applications the user is familiar with, for example, MICROSOFT® Word or COREL® WORDPERFECT®. Indeed, users of the software application of the present invention do not need to alter their work habits or submit information such as the Title of the Invention, Background of the Invention, Summary of the Invention, etc., in required fields or at specific locations within a document. Additionally, there is no need to learn new word processing applications, or train employees to use new word processing or other applications in order to prepare specifications, assignments, and the like.

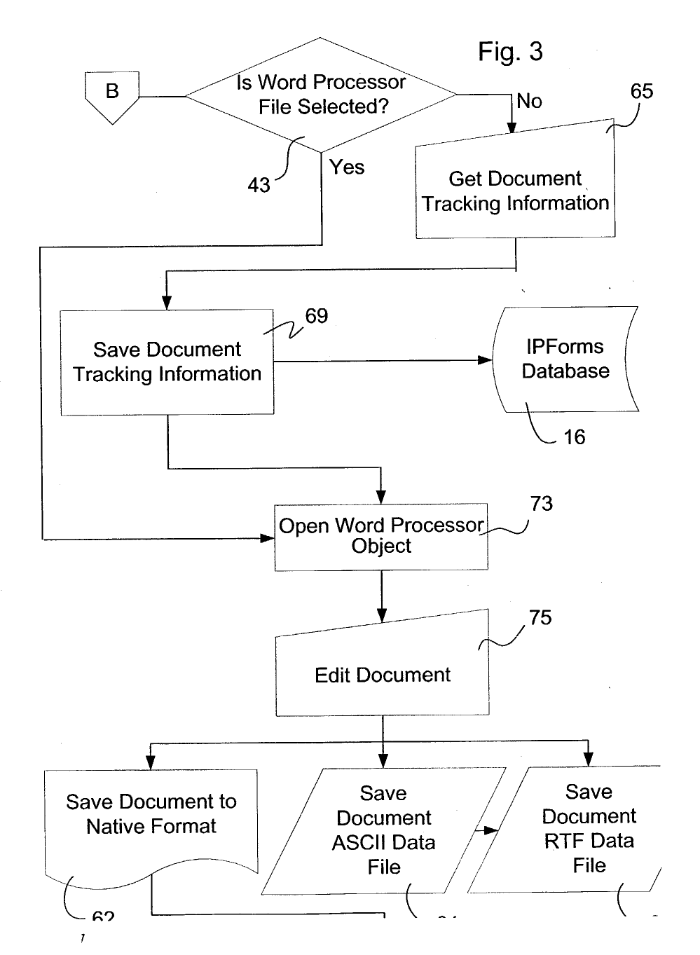

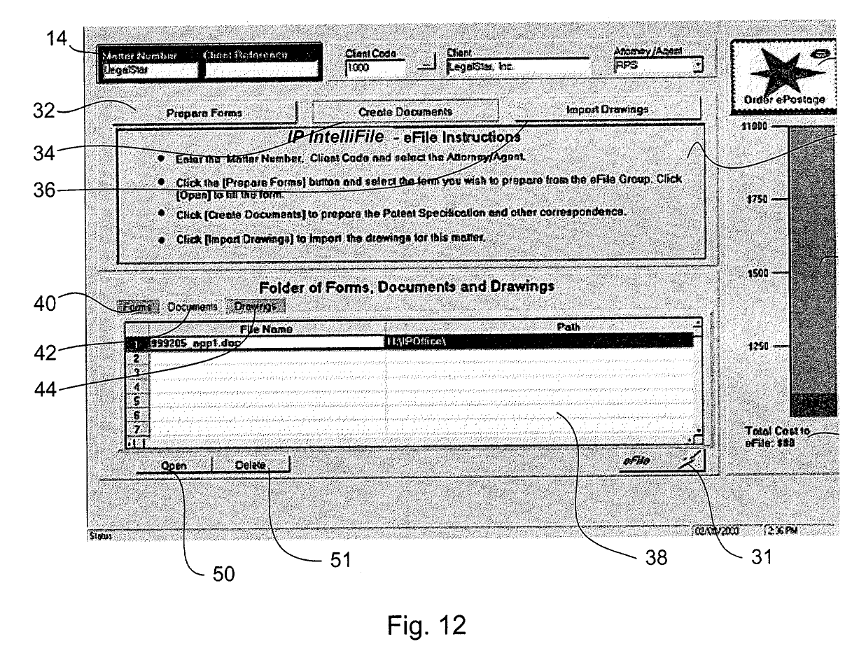

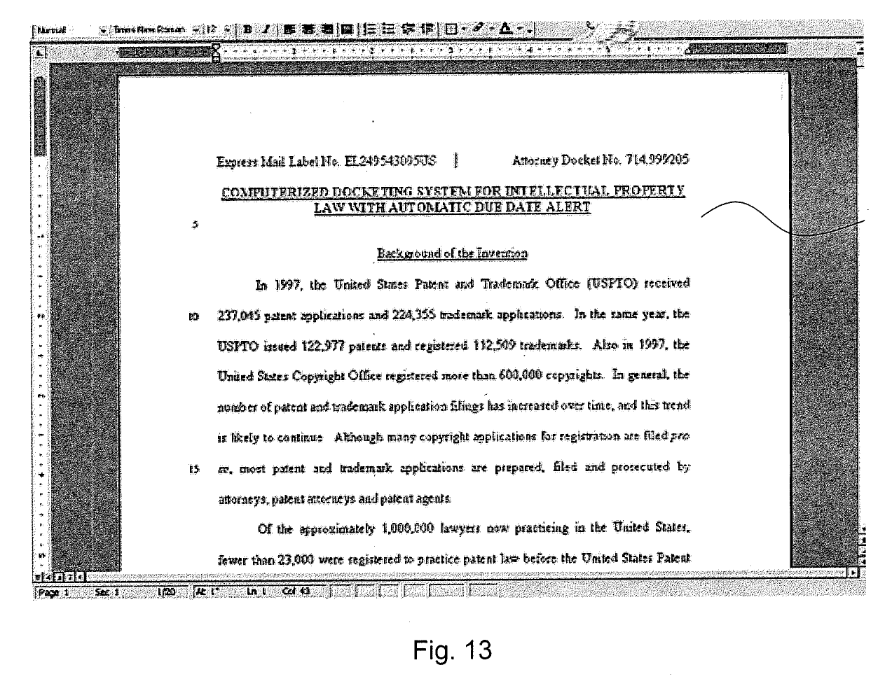

Referring now to FIGS. 1, 3, 12 and 13, if a user desires to create a new document or edit an existing document, the user may click “Create Documents” button 34 on main screen 12 (FIG. 9), which activates Document module 24 (FIG. 1). When “Create Documents” button 34 is selected, the filenames of all previously saved word processing document files (these may be patent application files, replies to Office Actions, and the like) associated with a particular matter are displayed in “Folder of Forms, Documents and Drawings” frame 38. If the user desires to edit an existing document, she may highlight the desired filename and click “Open” button 50. Clicking “Open” button 50 invokes a file selection identification procedure (method step 43 in FIG. 3) to determine whether the user selected a word processing document file. As shown in FIG. 12, the user has selected word processing document having File Name 999205.app1.doc (a MICROSOFT® Word document). When “Open” button 50 is clicked, a supported word processing application is launched (method step 73 in FIG. 3) and the selected word processing file 41 is opened (shown in FIG. 13). The open word processing document may then be edited (method step 75) as desired. As shown in FIG. 13, document file 41 comprises a patent application specification.

Alternatively, if the user desires to prepare a new document and/or no word processing files associated with a particular matter are displayed in “Folder of Forms, Documents and Drawings” frame 38, the user may select “Open” button 50, which allows a user to open a word processing application, such as MICROSOFT® Word or COREL® WORDPERFECT®. Upon selecting “Open” button 50, file selection identification procedure 43 is invoked. After determining that a word processing file has not been selected, the user is then prompted to provide file tracking information (method step 65 in FIG. 3), such as filename, file location, etc., which is then associated with the current matter and saved (method step 69 in FIG. 3) in IPForms database 16. Thereafter, the word processing application is launched (method step 73 in FIG. 3) and a new document opened for editing (method step 75 in FIG. 3). Alternatively, the user may desire to open a word processing application outside of the software application of the present invention and subsequently import the file. Once imported, closing the word processing document automatically saves the word processing file as a native word-processing file (method step 62 in FIG. 3) (a file having a .doc or .wpd file extension), text format (ASCII) data file (method step 64) and rich text format (rtf) data file (method step 66) in the IPForms database.

Drawing Module

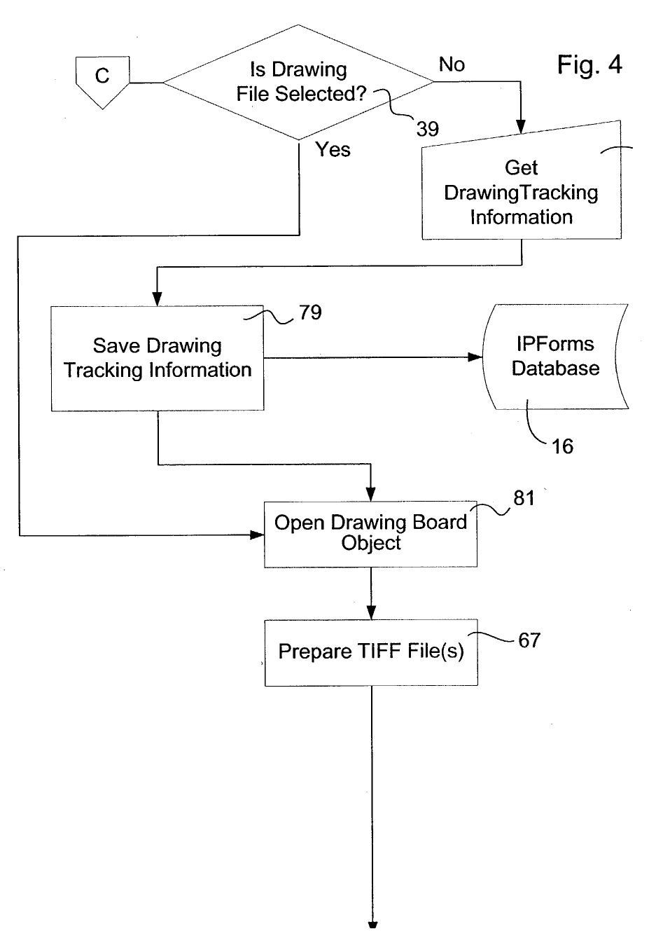

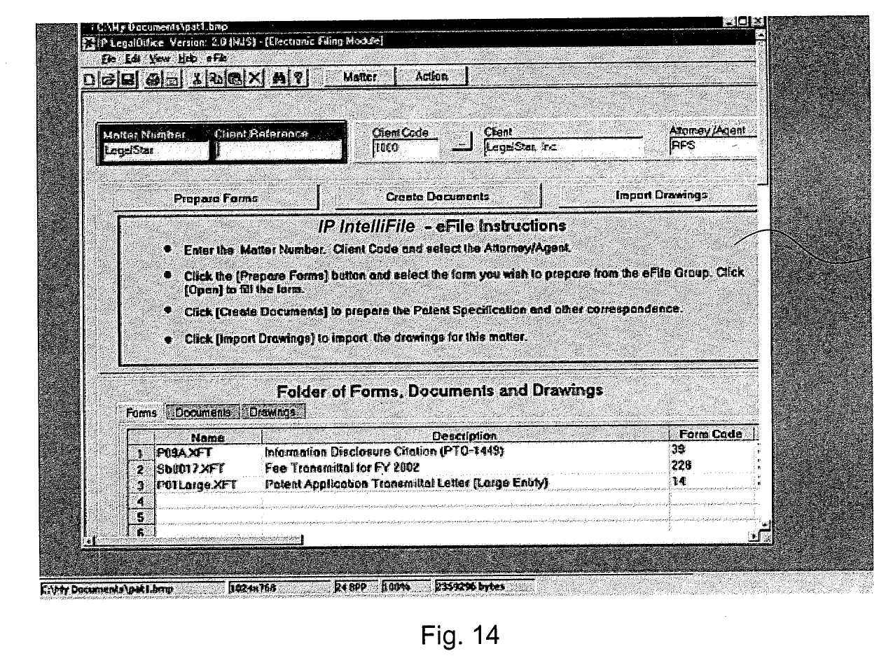

The software application of the present invention also allows users to view and import electronic drawings for transmission to an intended recipient. As shown in FIGS. 1, 4, 12 and 14, if a user desires to import drawing files, the user may click “Import Drawings” button 36 on main screen 12, which activates Drawing module 24. When “Import Drawings” button 36 is selected, the filenames of all previously saved drawing files associated with a particular matter are displayed in “Folder of Forms, Documents and Drawings” frame 38. If the user desires to open a drawing associated with the matter, the user may highlight the desired drawing filename and click “Open” button 50. Clicking “Open” button 50 invokes a file selection identification procedure (method step 33) to determine whether the user selected a drawing file. If a drawing file is selected, drawing component 81 is launched and the selected drawing file 37 is opened (See FIG. 13). The open drawing file may then be viewed and subsequently converted into a Tag Information Identification File (TIFF) file.

Alternatively, if the user desires to import a drawing file to be associated with the matter and/or no drawing files associated with a particular matter are displayed in “Folder of Forms, Documents and Drawings” frame 38, the user may select “Open” button 50. Upon selecting “Open” button 50, file selection identification procedure 33 is invoked. After determining that a drawing file has not been selected, the user is then prompted to perform file tracking procedures 77, such as file-open procedures utilizing filename, file location, etc. The drawings selected by the user are then associated with the current matter and saved in IPForms database 16 (method step 79). Thereafter, drawing component 81 is launched and the selected drawing file 37 opened into the drawing component 81. In either case, the subsequent closing of an open drawing file causes the Drawing module to automatically import and save the drawing file as a native drawing file and as a Tag Image Format File (TIFF) file 67 in the IPForms database.

ePostage Module

At the outset, it should be appreciated that “ePostage” is a trademark of LegalStar, Inc. of Williamsville, N.Y., used to describe software that enables payment and tracking of software license fees in correlation to electronic submission of documents to the United States Patent and Trademark Office. Any inadvertent descriptive or generic use of the ePostage trademark in this patent is not intended to adversely affect LegalStar's trademark rights.

As indicated supra, the software application of the present invention is adapted to allow users to pay transaction based “submission” and “correspondence” software license fees on a “pay-as-you-go basis”, account for the electronic submission and correspondence fees on a matter-by-matter, submission-by-submission basis, and communicate cost and fee information to commercially available time and billing software such as TIMESLIPS® time and billing software so that the fees can be automatically accounted for and charged directly to each client. The means for carrying out the above-identified operations generally comprise the ePostage module and the viewable ePostage frame.

The ePostage concept of the present invention is a unique method of paying software license fees and tracking expense for electronic filing of patent applications and related correspondence at the same time. In operation in a preferred embodiment, a user of the software of the invention purchases ePostage license credit over the Internet from a software provider, such as LegalStar. To initiate a purchase, the user clicks the “Order ePostage” icon 48 on main screen 12. Upon purchase, ePostage meter 46 on main screen 12 increments and also displays the amount of ePostage credit in the meter. As described below, the ePostage meter display is color-coded to alert the user when the meter is “running low” and in need of replenishment. Every time a user files a document electronically with the Patent Office using the software of the invention, the ePostage meter decrements.

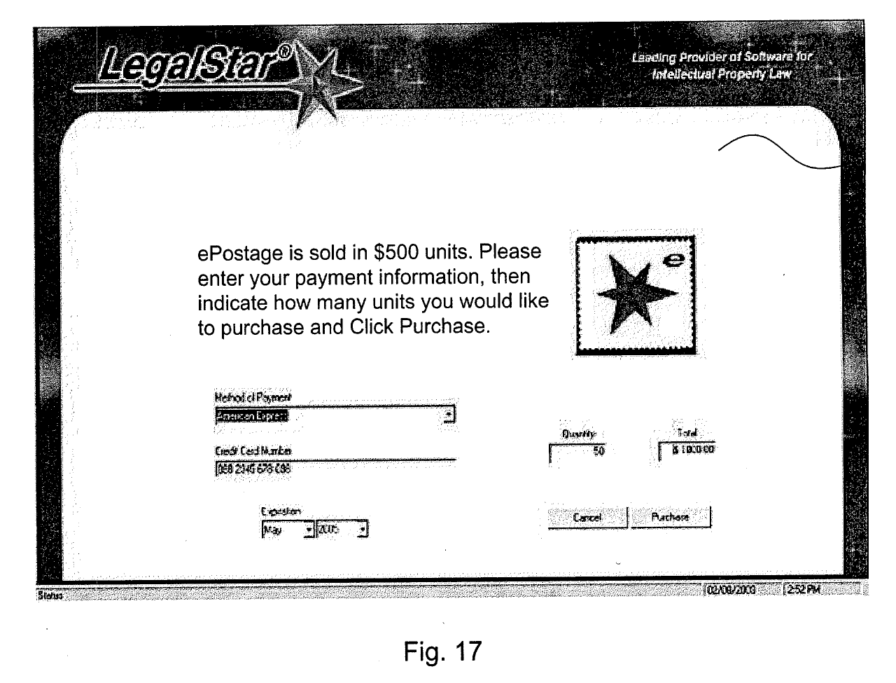

Referring now to FIGS. 1, 5, 9, 10, 12, 15, 16 and 17, in order to electronically submit patent and trademark related correspondence using the software application of the present invention, the user must pay a software license fee to the software developer. The present invention allows the user to open “ePostage” account 85 and purchase monetary credits from which software license fees may be debited. The invention correlates software license fees, payable on a “pay as you go” basis, with electronic submissions. In other words, every time a user uses the software to file a document electronically with the Patent Office, a software license fee is paid to the software developer. If a user desires to purchase ePostage credits, the user may do so by clicking Order ePostage button 48 from within ePostage frame 45. Clicking the Order ePostage button launches the ePostage order form 39 as shown in FIG. 17. Upon submitting the required information in the fields of the ePostage Order form, the user may electronically order ePostage credits as desired and the amount ordered will automatically accrue to her ePostage account.

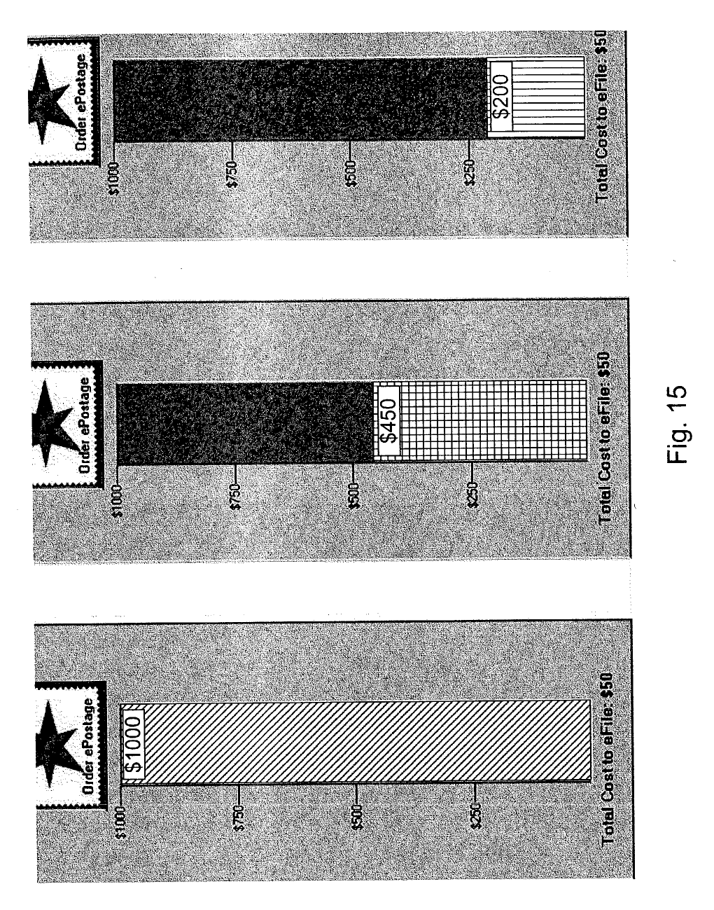

ePostage frame 45 of the present invention comprises ePostage meter 46, which allows a user to monitor the status of the balance of their ePostage account. In a preferred embodiment, the ePostage meter displays in green, yellow and red to indicate whether one has an ample, satisfactory or a low ePostage account balance, respectively (see FIG. 15). Upon purchasing ePostage credits, the ePostage meter is automatically adjusted to reflect the purchase. Alternatively, the Order ePostage form may be launched when the eFile module is activated and there is not sufficient ePostage credits in a user's account.

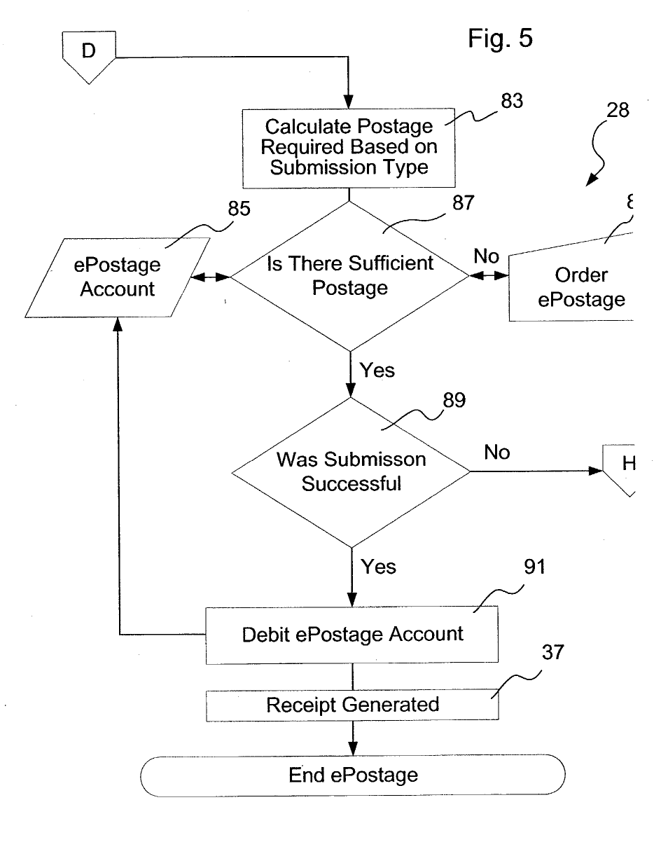

Referring now to FIG. 5, as indicated supra, electronic submission and correspondence fees may be debited on a “pay-as-you-go” basis and accounted for according to matter. Generally, the ePostage module calculates submission fees based on the submission type indicated by the user (method step 83). Upon entering the desired submission type, the ePostage module determines whether sufficient ePostage credit are present in the user's ePostage account (method step 87). If sufficient ePostage credits are present, the user is allowed to proceed to submit her correspondence and, upon receiving acknowledgement that the submission was successful (method step 89), submission license fees are automatically deducted from the user's ePostage account (method step 91) and an electronic receipt 35 of the deduction is generated (method step 106) and saved in the IPForms database. Hence, receipts may be opened, printed and forwarded to a client on an individual basis, or they may be communicated to commercially available time and billing software, such as TIMESLIPS®, so that the submission license fees can be automatically charged to each client at the time periodic billing statements are generated. Where it is determined that sufficient ePostage credits are not available based on the submission type, the user is prompted to order additional ePostage credits (method step 88) prior to proceeding through the submission process.

While in a preferred embodiment the payment of submission-based software license fees is debited from a user account, it should be appreciated that the present invention may be configured to debit electronic submission fees from other types of user accounts, e.g., credit card accounts, banking accounts (checking, savings and the like), and/or line of credit accounts.

eFile Module

The eFile module of the present invention renders the various form, document and drawing files into the proper format for transmission to the intended recipient. It should be appreciated that for purposes of electronically filing patent applications and related correspondence in the United States, the United States Patent and Trademark Office requires word processing type electronic files to be converted to extensible markup language (XML) format and drawing files to be placed in Tag Image File Format (TIFF). Additionally, the United States Patent and Trademark Office requires the identification of certain “fields” within a document; for example, with respect to a patent application, the Title, Background, Summary, Brief Description of the Drawings, etc., may be required to be identified. Hence, the present invention is specifically adapted to perform such identification and filtering operations via the eFile module.

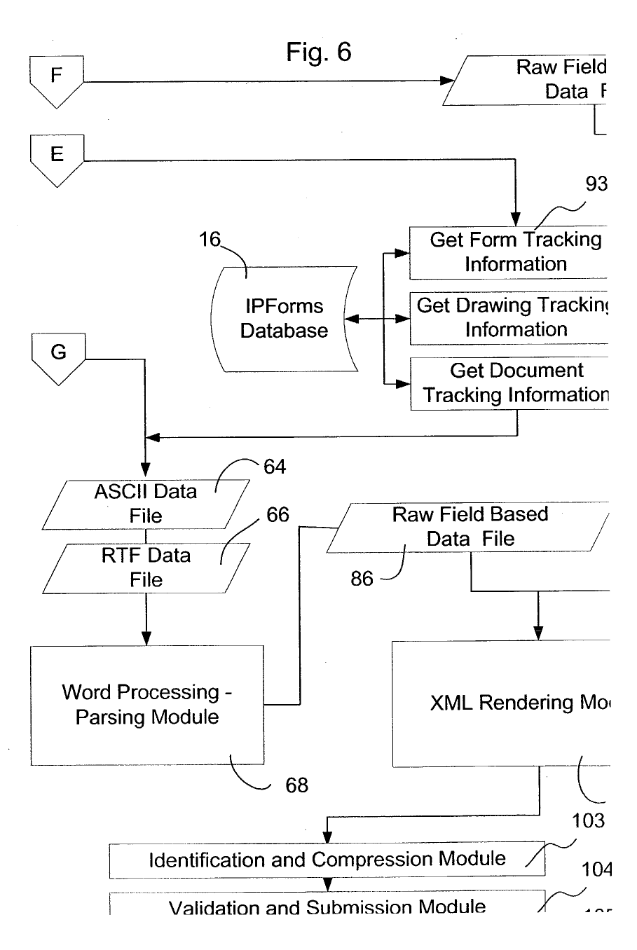

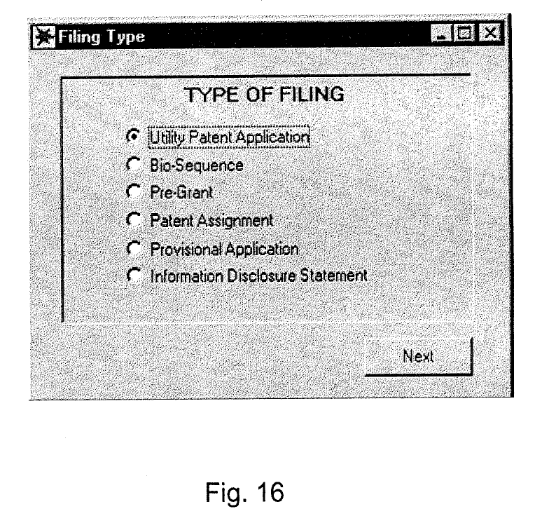

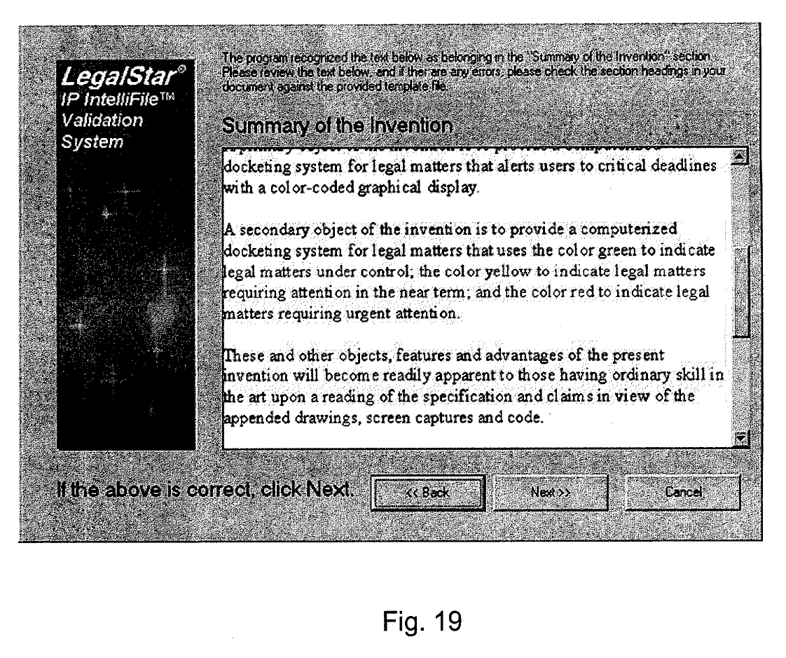

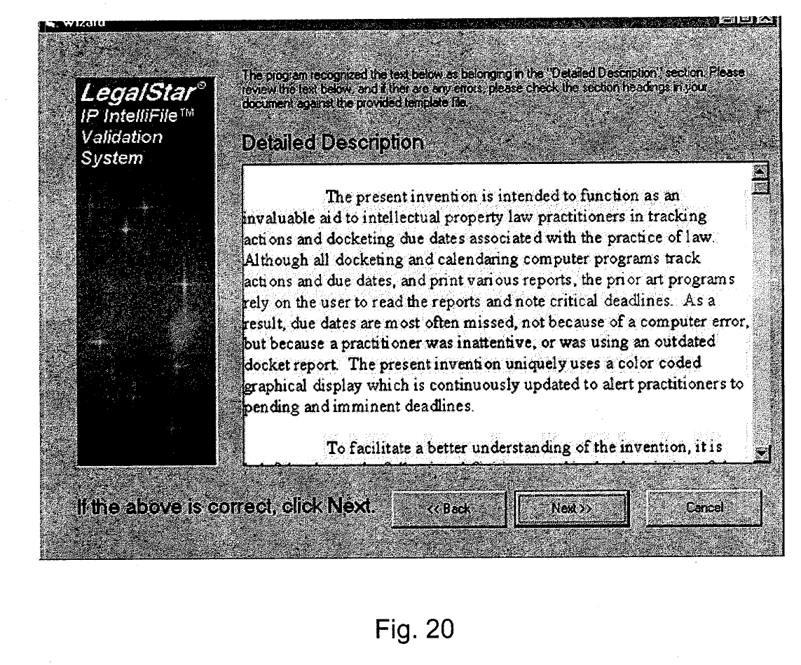

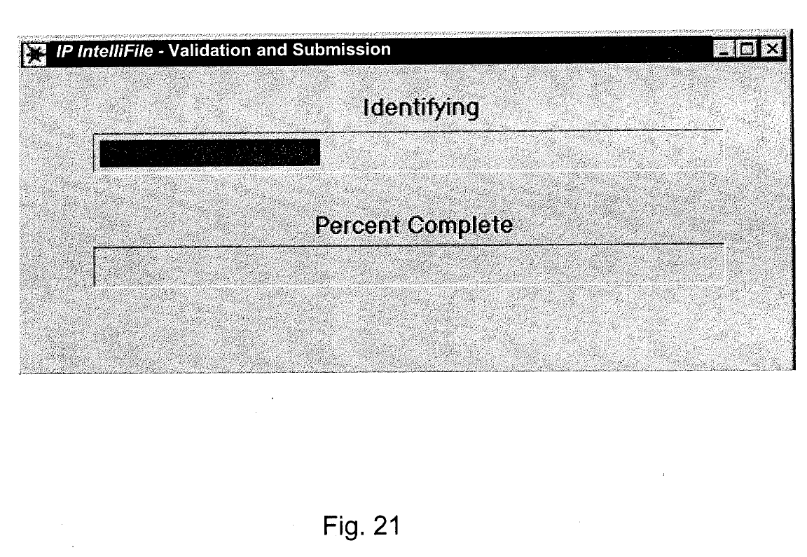

Referring now to FIGS. 1, 6-9, 16, and 18-21, the eFile module of the present invention generally functions as follows: upon clicking the eFile Module 31 button (see FIG. 9), the window of FIG. 16 is launched and the user is prompted to select the type of filing for purposes of calculating filing fees and validating whether all required documents or files are included with a particular submission. The submission types shown in FIG. 16 are provided solely to serve as examples of submission that may be made and it should be appreciated by those having ordinary skill in the art that the present invention is not limited to the specific submission types shown in FIG. 16. Upon entering a desired submission type and clicking the “Next” button, the eFile module determines whether sufficient ePostage credits are present to complete the submission based on submission type. Where sufficient ePostage credits are present, or the user purchases sufficient ePostage credits, the text format data (ASCII) files and rich text format data (rtf) files corresponding to the Document module are parsed so that a raw field data file can be created. To perform this operation Form tracking information 93, Drawing tracking information 77 and Document tracking information 65 for the matter are retrieved from the IPForms database. Raw field data file 86 corresponding to the Documents module and raw field data file 61 corresponding to the Forms module are then subjected to extensible markup language rendering module 70 to place the respective files in the proper format for electronic submission. If sufficient ePostage credits are not present, the screen of FIG. 17 is launched to prompt purchase of ePostage credits prior to performing the parsing and rendering operations.

As indicated supra, the present invention allows users to prepare patent applications and related correspondence using commercially available word processing applications, such as MICROSOFT® Word or COREL® WORDPERFECT®. Hence, because correspondence electronically filed with the United States Patent and Trademark Office is required to be submitted in an extensible markup language (XML) format, the native word processing files must be placed in this format prior to submission. To achieve this objective, text format (ASCII) data files 64 and rich text format (rtf) data files 66 corresponding to the Documents module must be analyzed, filtered and parsed so that they may be subsequently rendered into the required extensible markup language (XML) format.

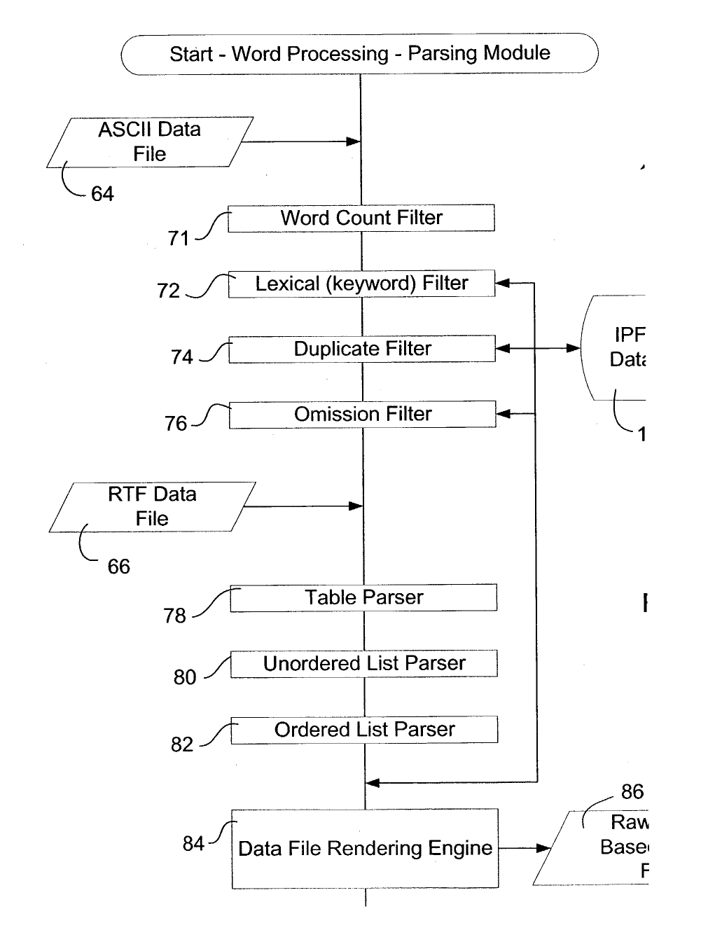

As shown in FIG. 7, parsing 68 of text data (ASCII) files 64 generally comprises submitting the files to a series of word count filters 71, keyword filters 72, duplicate filters 74, omissions filters 76, and the like. Generally, the word count, keyword, duplicate and omissions filters are provided to format the documents and identify the “fields” requiring identification as specified in the Document Type Definitions (DTD's) provided by the United States Patent and Trademark Office; for example, the “Detailed Description”, “Abstract”, etc. As such, the word count filter may be used to identify paragraphs comprising a maximum of words. Keyword filter 72, duplicate filter 74 and omissions filter 76 retrieve control parameters from IPForms database 16 and are used to identify specific terms such as “Detailed” or phrases such as “Background of the Invention”, reveal duplicative errors, and determine whether a document has omitted a required field, e.g. “Abstract”. Parsing 68 of the rich text format (rtf) files is generally used to identify and filter tables, lists, etc. that may be embedded within a word processing file. Hence, parsing 68 of the rich text format (rtf) files comprises subjecting the files to table parser 78, ordered list parser 82 and unordered list parser 80. As shown in FIG. 7, upon completion of the parsing of text data (ASCII) files 64 and rich text format (rtf) data files 66, the files are submitted to a data file rendering engine 84 to create raw field data file 86.

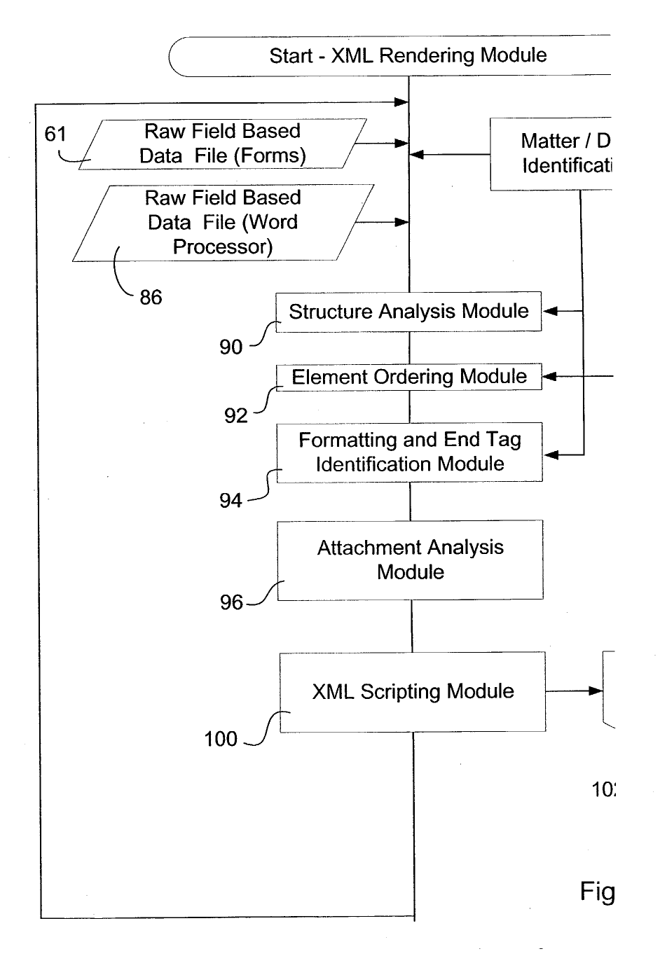

Once raw field data files 61 and 86 are prepared, they are then subjected to extensible markup language (XML) rendering module 70 to place them in proper format for electronic transmission to the United States Patent and Trademark Office. As shown in FIG. 8, based on the requirements contained in Matter/DTD Identification module 60, XML scripting module 100 compiles information obtained from structure analysis module 90, element ordering module 92, formatting and end tag module 94, and attachment module 96 to render XML file(s) 102. The structural analysis module, element ordering module, and formatting and end tag analysis module generally compare the raw field data files with the appropriate Data Type Definition (DTD) files, which is necessary to subsequently produce valid, well formed XML file(s). The attachment analysis generally determines and indicates whether any attachments are present, for example, sequence listings, program listings, etc. Thereafter, XML scripting module 100 renders the extensible markup language (XML) files.

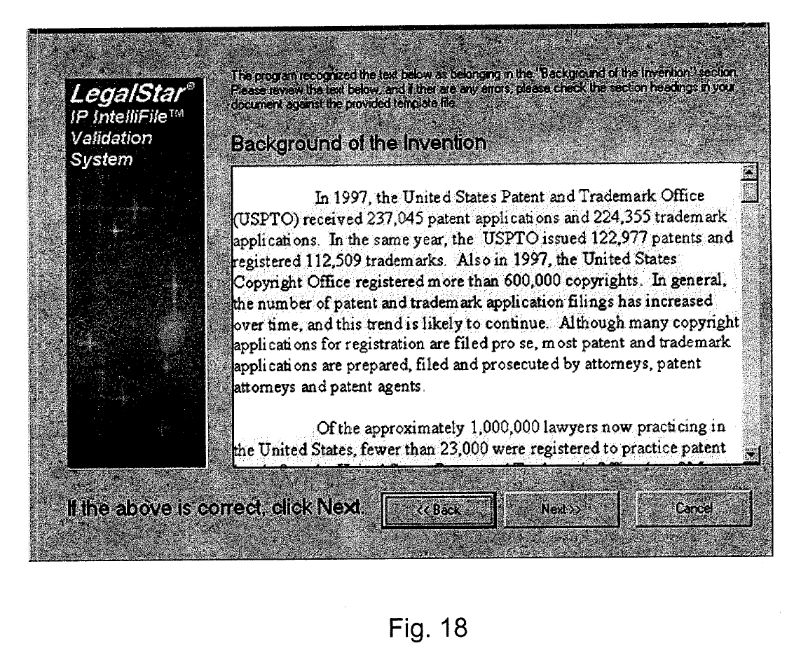

Upon creating the extensible markup language (XML) files, the files are identified and compressed 103 into a wrapped application document (WAD) for subsequent submission to an intended recipient. Thereafter, validation and submission module 104 prompts the user to review the parsed elements. Accordingly, as shown in FIGS. 18-20, a series of windows are launched so that the user may verify whether the “Background of the Invention”, “Summary of the Invention”, “Detailed Description” etc. were properly parsed and rendered. Similarly, other windows may be launched to verify whether certain drawings or other files are attached.

In one embodiment, the user verifies that all documents, files and forms, etc., have been parsed correctly, and then the WAD files along with an electronic signature are submitted by the validation and submission module 104, which is of a type well known in the art. Upon receiving notice from the intended recipient acknowledging that a successful submission was received, stamping and receipt module 105 debits submission fees (software license fees) from the user's ePostage account and a transaction receipt is saved in the IPForms database. It should be appreciated, however, that while a preferred embodiment comprises debiting electronic submission fees from a user account at the time the recipient acknowledges successful receipt of a submission, the present invention may be adapted such that electronic submission fees may be debited from a user account at any time.

Thus, it is seen that the objects of the present invention are efficiently obtained, and although modifications and changes to the invention may be readily apparent to those having ordinary skill in the art, it should be appreciated that such modifications are intended to be within the spirit and scope of the invention as claimed.

Components List

10 Present Invention

12 Main screen

14 Field

15 Tracking Module

16 IPForms Database

18 Matter Verification Module

20 Storage Module

22 Forms Module

24 Documents Module

26 Drawings Module

28 ePostage Module

30 eFile Module

31 eFile Button

32 Prepare Forms Button

33 File Selection Identification Procedure

34 Create Documents Button

35 Receipt

36 Import Drawings Button

37 Drawing File

38 Folder of Forms, Documents and Drawings Window

39 ePostage Order Form

40 Forms Tab

41 Word Processing File

42 Documents Tab

43 File Selection Identification Procedure

44 Drawings Tab

45 ePostage Frame

46 ePostage Meter

47 Forms List

48 ePostage Button

49 Add Button

50 Open Button

51 Delete Button

53 Instructions Frame

55 Select Procedure

56 Save Form Tracking Information Procedure

57 Form

58 Forms Native XML

59 Open Procedure

60 Matter/DTD Identification Module

61 Forms Raw Field Data File (after parsing)

62 Documents Native File

63 Input/Edit Procedure

64 Documents ASCII Data File

65 File Tracking Information

66 Documents RTF Data File

67 TIFF File

68 Parsing

69 Save Procedure

70 XML Rendering Module

71 Word Count Filter

72 Keyword Filter

73 Launch Procedure

74 Duplicate Filter

75 Edit Procedure

76 Omission Filter

77 File Tracking Procedure

78 Table Parser

79 Save Procedure

80 Unordered List Parser

81 Drawing Component

82 Ordered List Parser

83 Calculation Procedure

84 Data File Rendering Engine

85 ePostage Account

86 Raw Field Data File

87 Determination Procedure

88 User Prompt Procedure

89 Successful Submission

90 Structure Analysis Module

91 Deduction/Debit Procedure

92 Element Ordering Module

93 Form Tracking Information

94 Formatting and End Tag Module

96 Attachment Module

100 XML Scripting Module

102 XML Files

103 Compression Module

104 Validation and Submission Module

105 Stamping and Receipt Module

106 Receipt Generation

1. A computerized method for electronically preparing a file comprising the step of converting a native word processing source file into an extensible markup language file.

2. The method as recited in claim 1 wherein said native word processing source file comprises a .doc file extension.

3. The method as recited in claim 1 wherein said native word processing document comprises a .wpd file extension.

4. The method as recited in claim 1 further comprising transmitting said extensible markup language file to an intended recipient via a global information network.

5. The method as recited in claim 4 wherein said source file corresponds to a file selected from the group consisting of patent application, trademark application, and patent and trademark related correspondence.

6. A computerized method for electronically preparing a file comprising:
creating a text format (ASCII) file from a native word processing source file;
creating a rich text format (rtf) file from said native word processing source file;
filtering said text format and rich text format files to create a data file; and,
creating an extensible markup language file from said data file.

7. The method as recited in claim 6 wherein said native word processing source file comprises a .doc file extension.

8. The method as recited in claim 6 wherein said native word processing document comprises a .wpd file extension.

9. The method as recited in claim 6 further comprising transmitting said extensible markup language file to an intended recipient via a global information network.

10. The method as recited in claim 9 wherein said source file corresponds to a file selected from the group consisting of patent application, trademark application, and patent and trademark related correspondence.

11. A computer-based apparatus for electronically preparing a file comprising means for converting a native word processing source file into an extensible markup language file.

12. The apparatus as recited in claim 11 wherein said native word processing source file comprises a .doc file extension.

13. The apparatus as recited in claim 11 wherein said native word processing document comprises a .wpd file extension.

14. The apparatus as recited in claim 11 further comprising means for transmitting said extensible markup language file to an intended recipient via a global information network.

15. The apparatus as recited in claim 14 wherein said source file corresponds to a file selected from the group consisting of patent application, trademark application, and patent and trademark related correspondence.

16. A computer-based apparatus for electronically preparing a file comprising:
means for creating a text format (ASCII) file from a native word processing source file;
means for creating a rich text format (rtf) file from said native word processing source file;
means for filtering said text format (ASCII) and rich text format files to create a data file; and,
means for creating an extensible markup language file from said data file.

17. The apparatus as recited in claim 16 wherein said native word processing source file comprises a .doc file extension.

18. The apparatus as recited in claim 16 wherein said native word processing document comprises a .wpd file extension.

19. The apparatus as recited in claim 16 further comprising means for transmitting said extensible markup language file to an intended recipient via a global information network.

20. The apparatus as recited in claim 19 wherein said source file corresponds to a file selected from the group consisting of patent application, trademark application, and patent and trademark related correspondence.

21. A computer based apparatus for electronically submitting intellectual property related correspondence to an intended recipient comprising:
means for electronically submitting said correspondence to said recipient;
a user account comprising a monetary credit; and,
means for debiting said monetary credit from said user account according to type of correspondence submitted to said intended recipient.

22. The computer based apparatus as recited in claim 21 further comprising means for accounting for said monetary credit debited from said user account according to matter.

23. The computer based apparatus as recited in claim 22 wherein said means for accounting is operatively arranged to export information pertaining to said user account to time and billing software.

24. The computer based apparatus as recited in claim 21 further comprising indicating means for indicating the relative monetary balance of said user account.

25. The computer based apparatus as recited in claim 24 wherein said indicating means is visually displayed.

26. The computer based apparatus as recited in claim 21 wherein said user account is operatively arranged to communicate with an account selected from the group consisting of credit card account, banking account, and line of credit account.

27. The computer based apparatus as recited in claim 21 wherein said user account is debited at the time said recipient acknowledges successful receipt of a submission.

28. A computer based system for filing a patent application with a government agency, comprising:
means for electronically filing said patent application with said government agency;
an electronic postage meter operatively arranged to store electronic postage used for said electronic filing; and,
means for accounting for said electronically filed patent application, where said means for accounting is operatively arranged to account for said electronic postage used for said electronic filing.

29. The system recited in claim 28 wherein said postage meter comprises an icon displayed on a computer screen.

30. The system recited in claim 29 wherein said postage meter icon is color-coded and operatively arranged to change color depending on an amount of postage in said meter.

31. The system recited in claim 30 wherein said postage meter displays a green color when postage in said meter is above a predetermined level.

32. The system recited in claim 30 wherein said postage meter displays a yellow color when postage in said meter falls below a first predetermined level.

33. The system recited in claim 30 wherein said postage meter displays a red color when postage in said meter falls below a second predetermined level.

34. The system recited in claim 29 wherein said icon comprises a numerical display indicative of an amount of postage in said meter.

35. The system recited in claim 28 wherein said means for accounting tracks electronic postal expense by client.

36. The system recited in claim 28 wherein said means for accounting tracks electronic postal expense by client matter.

37. The system recited in claim 28 wherein said means for accounting tracks electronic postal expense by nature of correspondence filed electronically.

38. The system recited in claim 28 wherein said means for accounting is operatively arranged to store electronic filing postage data in a database.

39. The system recited in claim 38 wherein said means for accounting is operatively arranged to export said stored electronic filing postage data to time and billing software.

40. A system for electronic filing of patent applications, comprising:
means for electronic filing of said patent applications;
means for purchasing electronic postage from a third party vendor;
means for storing said purchased electronic postage in a postage meter; and,
means for deducting a predetermined amount of electronic postage from said postage meter when one of said patent applications is filed electronically with said system.

41. The system recited in claim 40 wherein said means for purchasing electronic postage is operatively arranged to purchase said electronic postage over a global computer information network.

42. The system recited in claim 40 wherein said means for electronic filing of said patent applications is operatively arranged to file said patent applications over a global computer information network.

43. The system recited in claim 40 further comprises means for accounting for said deducted predetermined amount of electronic postage.

44. The system recited in claim 43 wherein said means for accounting tracks electronic postal expense by client.

45. The system recited in claim 43 wherein said means for accounting tracks electronic postal expense by client matter.

46. The system recited in claim 43 wherein said means for accounting tracks electronic postal expense by nature of correspondence filed electronically.

47. The system recited in claim 43 wherein said means for accounting is operatively arranged to store electronic filing postage data in a database.

48. The system recited in claim 47 wherein said means for accounting is operatively arranged to export said stored electronic filing postage data to time and billing software.

49. A computer based method for preparing a document for electronic submission to the United States Patent and Trademark Office, comprising:
converting a file to XML according to a USPTO specification to enable electronic transmission of said document to the USPTO; and,
charging a transactional fee for said conversion, where said fee is based upon the nature of the file converted to XML.

50. The computer based method recited in claim 49 wherein a first fee is charged for conversion of a patent application file, and a second fee is charged for conversion of files other than patent application files.

51. The computer based method recited in claim 49 wherein said fee is collected upon successful transmission of the document.
